(19) United States
(12) Patent Application Publication
(10) Pub. No.: US 2024/0157965 A1
(43) Pub. Date: May 16, 2024

(54) DRIVING ASSISTANCE DEVICE AND DRIVING ASSISTANCE METHOD

(71) Applicant: DENSO CORPORATION, Kariya-city (JP)

(72) Inventors: Takeshi DOUWA, Tokyo (JP); Shinji KITAURA, Tokyo (JP)

(21) Appl. No.: 18/418,071

(22) Filed: Jan. 19, 2024

Related U.S. Application Data
(63) Continuation of application No. PCT/JP2022/027019, filed on Jul. 7, 2022.

(30) Foreign Application Priority Data
Jul. 20, 2021 (JP) 2021-119472

(51) Int. Cl. B60W 60/00; B60W 50/14

(52) U.S. Cl. CPC B60W 60/001; B60W 50/14; B60W 2555/00

(57) ABSTRACT

A driving assistance device includes a route storage unit configured to store in a storage unit route information including a travel route that a vehicle travels when a driver performs one of a parking operation of the vehicle into a parking space and an unparking operation of the vehicle from the parking space, and an environmental situation of the vehicle in the travel route. The route storage unit is further configured to, when the driver performs the one of the parking operation and the unparking operation, automatically initiate or terminate storing of the route information in the storage unit based on at least a relationship between a parking-lot entrance/exit and a current location of the vehicle. The driving assistance device further includes a route generation unit configured to generate a target route to be traveled by the vehicle when the vehicle is parked or unparked based on the route information.

### CROSS-REFERENCE TO RELATED APPLICATION

This application is a continuation application of International Application No. PCT/JP2022/027019 filed Jul. 7, 2022 which designated the U. S. and claims priority to Japanese Patent Application No. 2021-119472 filed with the Japan Patent Office on Jul. 20, 2021, the contents of each of which are incorporated herein by reference.

### BACKGROUND

### Technical Field

This disclosure relates to a driving assistance device and a driving assistance method.

### Related Art

Conventionally, a parking assistance method is known that stores an actual travel path in a route section specified by a driver of a vehicle using an operating unit, and automatically guides the vehicle based on the stored travel path.

### BRIEF DESCRIPTION OF THE DRAWINGS

In the accompanying drawings:

FIG. 1 is a schematic diagram of an automatic parking system according to a first embodiment;

FIG. 2 is an illustration of a situation where a vehicle is parked in the backward direction;

FIG. 3 is an illustration of an example of a travel route when a vehicle is unparked in the forward direction;

FIG. 4 is a flowchart of a learning process performed by a vehicle control unit according to the first embodiment;

FIG. 5 is an illustration of initiation and termination positions for storing route information according to the first embodiment;

FIG. 6 is a flowchart of a route-following control process performed by the vehicle control unit according to the first embodiment;

FIG. 7 is a flowchart of a target route generation process performed by the vehicle control unit according to the first embodiment;

FIG. 8 is an illustration of a modification example of a termination position for storing route information;

FIG. 9 is a flowchart of a part of a target route generation process performed by a vehicle control unit according to a second embodiment;

FIG. 10 is an illustration of a situation where a vehicle is unparked in the backward direction;

FIG. 11 is an illustration of an example of a travel route when a vehicle is parked in the forward direction;

FIG. 12 is a flowchart of a learning process performed by a vehicle control unit according to a third embodiment;

FIG. 13 is an illustration of initiation and termination positions for storing route information according to the third embodiment; and

FIG. 14 is a flowchart of a route-following control process performed by the vehicle control unit according to the third embodiment.

### DESCRIPTION OF SPECIFIC EMBODIMENTS

According to the known parking assistance method, as described in JP 2008-536734 A, it is necessary for the driver to specify start and end points of a route section for automatically guiding the vehicle, using the operating unit. This leads to an increased load on the driver in generating a target route for the vehicle, which is undesirable.

In view of the foregoing, it is desired to have a driving assistance device and a driving assistance method, capable of reducing the driver's load associated with generation of a target route for the vehicle.

One aspect of the present disclosure provides a driving assistance device for assisting a driver in driving operations of a vehicle between a public road and a parking space in a lot along the public road. The driving assistance device includes a route storage unit is configured to store in a storage unit route information including a travel route that the vehicle travels when the driver performs one of a parking operation of the vehicle into the parking space and an unparking operation of the vehicle from the parking space, and an environmental situation of the vehicle in the travel route. The route storage unit is further configured to, when the driver performs the one of the parking operation and the unparking operation, automatically initiate or terminate storing of the route information in the storage unit based on at least a relationship between a parking-lot entrance/exit, which is a boundary between the public road and the lot, and a current location of the vehicle. The driving assistance device further includes a route generation unit is configured to generate a target route to be traveled by the vehicle when the vehicle is parked or unparked based on the route information.

Another aspect of the present disclosure provides a driving assistance method for assisting a driver in driving operations of a vehicle between a public road and a parking space in a lot along the public road. The driving assistance method includes storing in a storage unit route information including a travel route that the vehicle travels when the driver performs one of a parking operation of the vehicle into the parking space and an unparking operation of the vehicle from the parking space, and an environmental situation of the vehicle in the travel route, where storing in a storage unit route information includes, when the driver performs the one of the parking operation and the unparking operation, automatically initiating or terminating storing of the route information in the storage unit based on at least a relationship between a parking-lot entrance/exit, which is a boundary between the public road and the lot, and a current location of the vehicle. The driving assistance method further includes generating a target route to be traveled by the vehicle when the vehicle is parked or unparked based on the route information.

In such a configuration that storing of the travel route in the storage unit is automatically initiated or terminated based on the parking-lot entrance/exit, the load on the driver associated with generation of the target route can be reduced, as compared to the case where the driver specifies the timing for initiating or terminating storing of route information.

Hereinafter, exemplary embodiments of the present disclosure will be described in detail with reference to the accompanying drawings. In the following embodiments, items that are the same or equivalent to those described in the preceding embodiments will now be assigned with the same reference numerals and description of such items may be omitted. When only some of the components are described in the embodiments, the components described in the preceding embodiments may be applied to the other components. In the following embodiments, respective embodiments may be partially combined with each other, even if not specifically indicated, provided that there is no obstacle to the combinations.

### FIRST EMBODIMENT

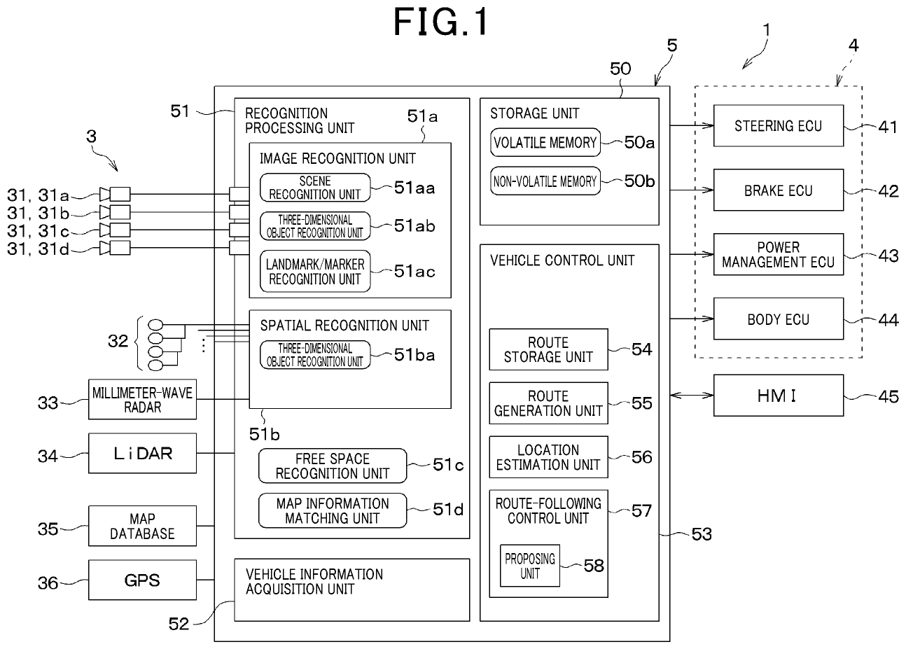

The present embodiment will now be described with reference to FIGS. 1 to 7. In the present embodiment, a driving assistance device 5 and a driving assistance method of the present disclosure will be described as applied to an autonomous driving system 1. As illustrated in FIG. 1, the autonomous driving system 1 includes surroundings monitoring sensors 3, various ECUs 4, and the driving assistance device 5. The driving assistance device 5 is communicatively connected to the surroundings monitoring sensors 3 and various ECUs 4 directly or through an in-vehicle local area network (LAN) or the like.

The surroundings monitoring sensors 3 are autonomous sensors that monitor a surrounding environment of a vehicle carrying the surroundings monitoring sensors 3 (hereinafter referred to as an own vehicle). For example, the surroundings monitoring sensors 3 detect obstacles OB that are three-dimensional objects around the own vehicle including dynamic targets, such as pedestrians and other vehicles, and static targets, such as structures on roads, and parking assistance markings indicative of parking information that is information about parking lots PL. The surroundings monitoring sensors 3 include surroundings monitoring cameras 31 that capture images of a predefined region around the own vehicle, and probe wave sensors, such as sonar 32, millimeter-wave radar 33, and light detection and ranging (LiDAR) 34 that emit probe waves to a predefined region around the own vehicle.

The surroundings monitoring cameras 31, which correspond to imaging devices, capture images of surroundings of the own vehicle and output imaging data to the driving assistance device 5 as sensing information. In the present embodiment, the surroundings monitoring cameras 31 include, but are not limited to, a front camera 31a, a rear camera 31b, a left-side camera 31c, and a right-side camera 31d to capture forward, rearward, leftward, and rightward images of the own vehicle.

The probe wave sensors emit probe waves and acquire reflected waves, and thereby output to the driving assistance device 5 measurements as sensing information, such as a relative speed, a relative distance, and an azimuth angle of a target relative to the own vehicle. The sonar 32, which performs measurement using ultrasonic waves as probe waves, are disposed in a plurality of positions on the vehicle V. For example, a plurality of sonars are disposed on the front and rear bumpers in the lateral direction of the vehicle to perform measurement by outputting probe waves toward surroundings of the vehicle. The millimeter-wave radar 33 performs measurement using millimeter waves as probe waves, and the LiDAR 34 performs measurement using laser light as probe waves. Both the millimeter-wave radar 33 and the LiDAR 34 emit probe waves to within a predefined region ahead of the vehicle V, for example, and perform measurement within the predefined region.

In the present embodiment, the surroundings monitoring sensors 3 include the surroundings monitoring cameras 31, the sonars 32, the millimeter-wave radar 33, and the LiDAR 34. Surroundings monitoring may be performed by combinations of one or more of these sensors, and all of these sensors do not have to be provided.

The driving assistance device 5 is connected to the map database 35 and GPS 36 and is capable of positioning the current location of the own vehicle V. The map database 35 may be built in an in-vehicle device or in an external device (e.g., an external server).

The driving assistance device 5 is configured as an electronic control unit (ECU) that performs various types of control to implement a driving assistance method in the autonomous driving system 1.

The storage unit 50 includes a read only memory (ROM), a random access memory (RAM), an electrically erasable programmable read-only memory (EEPROM), and the like. That is, the storage unit 50 includes a volatile memory 50a, such as a RAM, and a non-volatile memory 50b, such as an EEPROM. The storage unit 50 is configured as a non-transitory tangible storage medium.

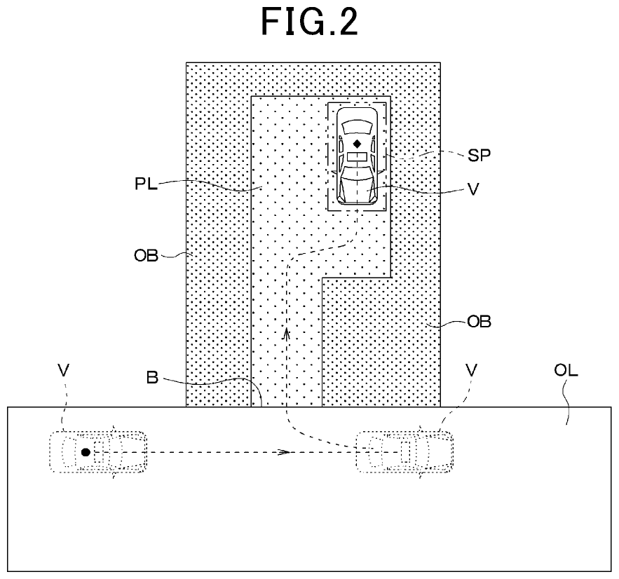

The driving assistance device 5 assists the driving operations of the vehicle V by the driver between a public road OL and a parking space SP in a lot along the public road OL. The present embodiment of the driving assistance assistance device 5 assists the parking operation of the vehicle V in the parking space SP, as illustrated in FIG. 2. Although FIG. 2 illustrates a situation where the vehicle V is parked in the parking space in the backward direction, driving assistance by the driving assistance device 5 may be implemented not only when the vehicle V is parked in the backward direction in the parking space, but also when the vehicle V is parked in the forward direction in the parking space.

The driving assistance device 5 generates a target route to be traveled by the vehicle V when the vehicle V is parked based on route information including the travel route of the vehicle V when a parking or unparking operation of the vehicle V was performed by the driver and surroundings of the vehicle V on that travel route. During driving assistance, the parking assistance device 5 automatically moves the vehicle V along the target route to the parking space SP at the estimated parking location, or automatically moves the vehicle V from the parking space SP to a predefined location.

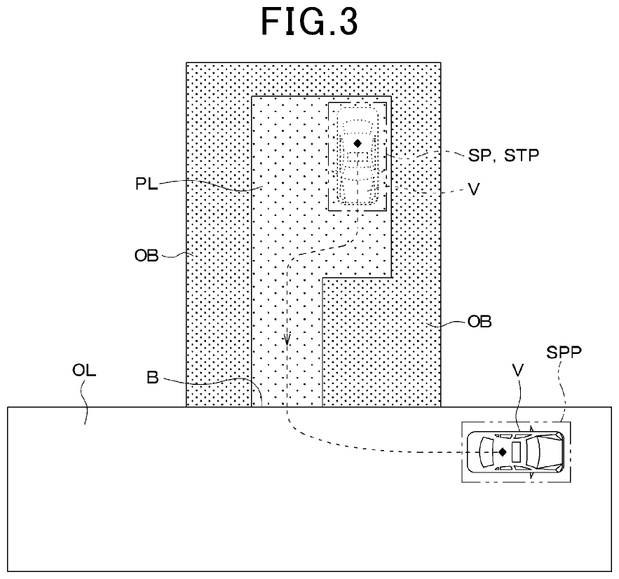

As illustrated in FIG. 3, for example, the driving assistance device 5 stores in the storage unit 50 route information including the travel route of the vehicle V and the environmental situation in the travel route acquired sequentially by the recognition processing unit 51, as described later, when an unparking operation of the vehicle V is performed by the driver. For example, as illustrated in FIG. 2, the driving assistance device 5 may store route information acquired sequentially by the recognition processing unit 51 in the storage unit 50 when the parking operation of the vehicle V is performed by the driver. In this manner, the driving assistance device 5 performs a learning process to store route information when the driver is manually driving the vehicle. This learning process is automatically initiated or terminated based on the relationship between the current location of the vehicle V and the parking-lot entrance/exit B, which is the boundary between the public road OL and the parking lot PL. Driving assistance is also performed when the driver provides an instruction for driving assistance. The parking lot PL is a lot along the public road OL, where a parking space SP for the vehicle V is provided. The “environmental situation of the vehicle V” is, for example, a situation of dynamic targets such as persons or other vehicles around the vehicle V, static targets such as curbs or buildings around the vehicle V, various markings, road markings such as guide lines, and so on.

While traveling from the initiation position STP to the termination position SPP for the learning process, the driving assistance unit 5 recognizes targets on the travel route of the vehicle V, free spaces in which the vehicle V can be parked, parking locations, etc., based on sensing information from the surroundings monitoring sensors 3. These recognition results are stored in the storage unit 50 as route information and used during driving assistance.

The driving assistance device 5 performs various types of control for generation of target routes and driving assistance based on route information stored in the storage unit 50 and route information acquired sequentially by the recognition processing unit 51 during driving assistance. That is, upon receiving an instruction for driving assistance, the driving assistance device 5 generates a target route based on the sensing information stored in the storage unit 50 and the sensing information from the surroundings monitoring sensors 3 during driving assistance, and performs route-following control according to the target route. Specifically, the driving assistance device 5 is configured as having a recognition processing unit 51, a vehicle information acquisition unit 52, and a vehicle control unit 53 as functional blocks that perform various types of control.

The recognition processing unit 51 receives sensing information from the surroundings monitoring sensors 3 and, based on the sensing information, recognizes the surrounding environment of the own vehicle that is going to park, recognizes what kind of parking scene, and also recognizes three-dimensional objects in the vicinity of the own vehicle. Here, the recognition processing unit 51 includes an image recognition unit 51a, a spatial recognition unit 51b, a free spatial recognition unit 51c, and a map information matching unit 51d.

The image recognition unit 51a includes a scene recognition unit 51aa, a three-dimensional object recognition unit 51ab, and a landmark/marker recognition unit 51ac. These perform scene recognition, three-dimensional object recognition, and landmark/marker recognition by receiving imaging data from surroundings monitoring cameras 31 as sensing information and analyzing the imaging data.

In scene recognition, the scene recognition section 51aa recognizes what kind of parking scene the parking scene is, for example, whether the parking scene is a normal parking scene where there is room in the aisle width of the route to the parking space SP or a special parking scene where there is no room in the aisle width of the route to the parking space SP due to presence of obstacles OB.

Since the imaging data input from the surroundings monitoring cameras 31 provides images of the surroundings, analyzing the images allows a determination to be made as to whether the parking scene is a normal parking scene or a special parking scene. For example, the frontage of the parking space SP is calculated from the imaging data, and when the frontage is within a range predefined based on the width of the own vehicle, it can be determined that the parking scene is a special parking scene. Scene recognition may be performed based not only on sensing information from the surroundings monitoring cameras 31, but also on sensing information from the probe wave sensors.

In three-dimensional object recognition, obstacles OB constituted by three-dimensional objects such as dynamic and static targets that are present around the own vehicle are recognized as objects subject to detection. Based on these objects recognized in three-dimensional object recognition, preferably shapes of static targets among these objects, scene recognition described above and generation of a driving assistance map including obstacles OB are performed.

In landmark/marker recognition, landmarks indicating parking spaces SP, graphical markings indicating parking lots PL, graphical markings indicating parking directions, 2D barcodes indicating parking scenes, parking directions, etc., are recognized. Based on the markings recognized by landmark/marker recognition, scene recognition described above is performed. For example, a parking assistance marking indicating a parking scene and other parking information may be provided in the parking space SP or in front of it, and when the parking assistance marking is found in the imaging data, the type of parking scene indicated by the parking assistance marking may be recognized.

The spatial recognition unit 51b includes a three-dimensional object recognition unit 51ba. The three-dimensional object recognition unit 51ba recognizes three-dimensional objects in the space around its own vehicle based on sensing information from at least one of the sonar 32, the millimeter-wave radar 33, and the LiDAR 34. The three-dimensional object recognition here is similar to that performed by the image recognition unit 51a. Therefore, three-dimensional object recognition may be performed if at least either the image recognition unit 51a or space recognition unit 51b is included. In the present embodiment, although scene recognition is not performed in the spatial recognition unit 51b, scene recognition may be performed in the spatial recognition unit 51b based on sensing information from at least one of the sonar 32, the millimeter-wave radar 33, and the LiDAR 34.

Although three-dimensional object recognition and scene recognition may be performed by either the image recognition unit 51a or the spatial recognition unit 51b, it is possible to perform more accurate three-dimensional object recognition and scene recognition by using both. For example, by complementing three-dimensional object recognition and scene recognition by the image recognition unit 51a with three-dimensional object recognition and scene recognition by the spatial recognition unit 51b, it is possible to perform three-dimensional object recognition and scene recognition with higher accuracy.

The free space recognition unit 51c performs free space recognition to recognize free spaces within a parking lot PL. A free space means, for example, a space of a size and shape that allows the vehicle V to travel in the parking lot PL.

The free space recognition unit 51c recognizes free spaces in the parking lot PL based on results of scene recognition and three-dimensional object recognition by the image recognition unit 51a and the spatial recognition unit 51b. Since the free space recognition unit 51c can know the shape of the parking lot PL and whether other vehicles are parked in the parking lot PL based on the results of scene recognition and three-dimensional object recognition, the free space recognition unit 51c recognizes free spaces within the parking lot PL based on the results of scene recognition and three-dimensional object recognition.

The map information matching unit 51d identifies the current location of the vehicle V on the map by acquiring map information from the map database 35 and matching the acquired map information with location information acquired by the GPS 36. The map information matching unit 51d may use information other than the map information from the map database 35 and the location information acquired by the GPS 36 to identify the current location of the vehicle V.

The vehicle information acquisition unit 52 acquires information about the operation amounts of the vehicle V from other ECUs 4 or the like. Specifically, the vehicle information acquisition unit 52 acquires detection signals output from sensors mounted to the vehicle V, such as an accelerator position sensor, a brake pedal force sensor, a steering angle sensor, a wheel speed sensor, a shift position sensor, etc.

The vehicle control unit 53 performs various types of control required for driving assistance. Specifically, the vehicle control unit 53 includes a route storage unit 54, a route generation unit 55, a location estimation unit 56, and a route-following control unit 57 as functional blocks for performing various types of control.

The route storage unit 54 stores in the storage unit 50 route information including the travel route that the vehicle V travels when the driver performs any one of the parking operation of the vehicle V into the parking space SP and the unparking operation of the vehicle V from the parking space SP, and the environmental situation of the vehicle V in that travel route. The route storage unit 54 of the present embodiment stores in the storage unit 50 route information when the driver performs the unparking operation of the vehicle V from the parking space SP. Specifically, the route storage unit 54 stores in the storage unit 50 route information sequentially acquired by the recognition processing unit 51, including targets on the travel route of the vehicle V, free spaces in which the vehicle V can be parked, and parking locations.

The route storage unit 54 has a location determination function that uses the map database 35 and the GPS 36 to determine a relationship between the parking-lot entrance/exit B, which is the boundary between the public road OL and the parking lot PL, and the current location of the vehicle V. The route storage unit 54 automatically initiates or terminates storing of route information in the storage unit 50 based on the relationship between the parking-lot entrance/exit B, which is the boundary between the public road OL and the parking lot PL, and the current location of the vehicle V when the driver performs the unparking operation of the vehicle V. Specifically, the route storage unit 54 automatically initiates storing of route information in response to the departure operation of the vehicle V from the parking space SP. Then, the route storage unit 54 automatically terminates storing of the route information in the storage unit 50 based on the relationship between the current location of the vehicle V and the parking-lot entrance/exit B when the driver performs the unparking operation.

The route generation unit 55 performs route generation based on the results of scene recognition, three-dimensional object recognition and free space recognition. The route generation unit 55 generates a target route to be traveled by the vehicle V when the vehicle V is parked into or unparked from the parking space SP, based on the route information stored during the learning process and other information. For example, the route generation unit 55 uses the travel route of the vehicle V as a reference route. In a case where there is a section in the reference route where a distance between the vehicle V and an obstacle OB is less than or equal to a predefined value, the route generation unit 55 generates a target route by replacing the section with a route where the distance between the vehicle V and the obstacle OB exceeds the predefined value. The obstacle OB consists of three-dimensional objects recognized by three-dimensional object recognition.

Here, although the route generation unit 55 avoids obstacles OB when generating the target route, the route generation unit 55 may generate the target route by avoiding only static targets among the obstacles. Since dynamic targets are moving or will eventually move, the vehicle V may be moved only after the risk of collision with a dynamic target is eliminated, in which case it is sufficient to generate a target route taking into account only the static targets.

The location estimation unit 56 estimates the current location of the vehicle V based on the route information stored in the storage unit 50 and the route information acquired sequentially by the recognition processing unit 51 during driving assistance. The location estimation unit 56, for example, compares the sensing information stored in the storage unit 50 with the sensing information acquired during driving assistance and estimates the current location based on a difference between them.

The route-following control unit 57 automatically moves the vehicle V along the target route to the parking space SP by performing vehicle movement control such as acceleration/deceleration control and steering control of the vehicle V. Specifically, the route-following control unit 57 outputs control signals to various ECUs 4 so that the vehicle V reaches the parking space SP along the target route.

The various ECUs 4 include a steering ECU 41 that controls steering, a brake ECU 42 that controls acceleration and deceleration, a power management ECU 43, and a body ECU 44 that controls various types of control of electrical components such as lights, door mirrors, etc.

Specifically, the route-following control unit 57 acquires, via the vehicle information acquisition unit 52, detection signals output from the respective sensors mounted to the vehicle V, such as the accelerator position sensor, the brake pedal force sensor, the steering angle sensor, the wheel speed sensor, and the shift position sensor. The route-following control unit 57 detects a state of each of various parts from the acquired detection signals and outputs control signals to the various ECUs 4 to cause the vehicle V to move following the target route.

There may be a static target that had not been recognized when the target route was first calculated. Therefore, three-dimensional object recognition by the three-dimensional object recognition units 51ab and 51ba is continued even in the process of the vehicle V traveling along the target route. In a case where a static target exists at a location where a collision with the vehicle V may occur when the vehicle V travels along the target route, a target route is re-generated. For example, a person or another vehicle may approach the vehicle V when the vehicle V is moved from its current location to the parking space SP. In such a case, the route-following control unit 57 suspends movement of the vehicle V until the dynamic target falls outside an area of an estimated travel trajectory of the vehicle V, which is estimated from the target route and the vehicle width, to prevent the vehicle V from colliding with the dynamic object.

The route-following control unit 57 includes a proposing unit 58 that proposes a target route to the driver. The proposing unit 58 makes various proposals, including driving assistance, to the driver via a human machine interface (HMI) 45. The HMI 45 is a device for providing various types of assistance to the driver. The HMI 45 functions as a notification device that includes an ECU, a display, a speaker, etc. The proposing unit 58 is not dedicated to the route-following control unit 57, but may be used in conjunction with other functional blocks.

As described above, the autonomous driving system 1 according to the present embodiment is configured. Operations of the autonomous driving system 1 thus configured will now be described. The present embodiment will now be described using a case in which the vehicle V is parked in a parking space SP provided in a parking lot PL along a public road OL, as illustrated in FIG. 2. The parking lot PL illustrated in FIG. 2 includes a pathway from the public road OL to the parking space SP with a pathway width allowing one vehicle V to pass through. FIG. 2 also illustrates reverse parking, in which the vehicle V is moved backward and parked in the parking space SP.

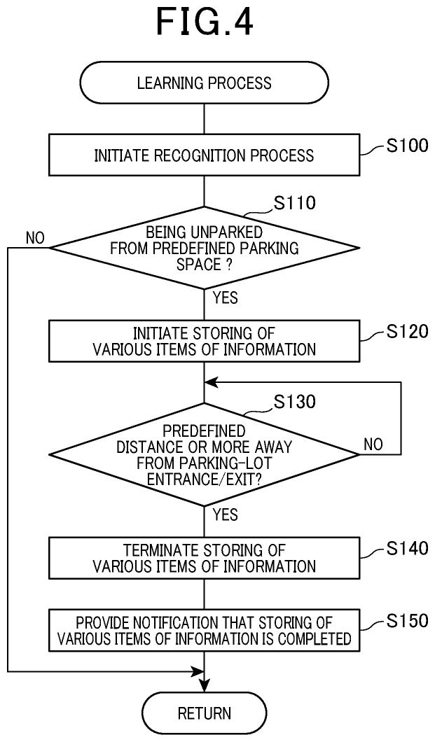

First, the learning process for storing route information during manual driving by the driver will now be described with reference to the flowchart in FIG. 4. The learning process illustrated in FIG. 4 is performed by the vehicle control unit 53 every predefined control cycle when the driver is instructed to cause the vehicle to depart from the parked state, such as when the ignition switch IG is turned on. The steps in this flowchart are implemented by respective functional blocks of the driving assistance device 5. The steps implementing this process are also understood as respective steps implementing the driving assistance method.

As illustrated in FIG. 4, the vehicle control unit 53 initiates a recognition process at step S100. In this recognition process, the vehicle control unit 53 receives sensing information from the surroundings monitoring sensors 3 and initiates scene recognition, three-dimensional object recognition, and free space recognition described above based on the received sensing information. In the recognition process, the vehicle control unit 53 also initiates detection of the current location of the vehicle V using the map database 35 and the GPS 36.

Subsequently, at step S110, the vehicle control unit 53 determines whether the vehicle V is going to be unparked from the predefined parking space SP. The vehicle control unit 53 determines whether the current location of the vehicle V is in the parking space SP registered previously with the storage unit 50 or the like, and the presence or absence of the departure operation such as changing the shift position to the driving position of the vehicle (e.g., the D or R position). The predefined parking space SP is, for example, a place that the driver registered previously with the navigation system or the like as a parking space SP in front of the driver's home.

The vehicle control unit 53 proceeds to step S120 if the vehicle is unparked from the predefined parking space SP, or skips the subsequent steps and exits the learning process if the vehicle is not unparked from the predefined parking space SP. At step S120, the vehicle control unit 53 initiates storing of various items of information necessary for driving assistance. The vehicle control unit 53 stores in the storage unit 50 route information sequentially acquired by the recognition processing unit 51, including the travel route of the vehicle V and the environmental situation of the travel route.

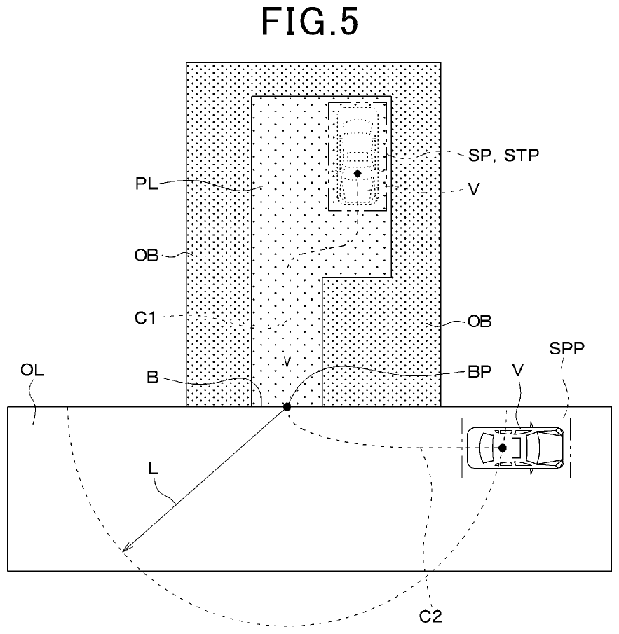

At step S130, the vehicle control unit 53 determines whether the vehicle V has traveled a predefined distance L or more away from the parking-lot entrance/exit B after departing from the parking space SP. The predefined distance L is set to a value greater than zero. In this determination process, as illustrated in FIG. 5, it is determined whether the current location of the vehicle V is outside the area defined by the predefined distance L from the reference point BP set at the parking-lot entrance/exit B on the public road OL.

If the distance between the vehicle V and the parking-lot entrance/exit B on the public road OL is less than the predefined distance L, the vehicle control unit 53 waits. If the distance between the vehicle V and the parking-lot entrance/exit B on the public road OL is greater than or equal to the predefined distance L, the vehicle control unit 53 proceeds to step S140 to terminate storing of various items of information.

Here, the route information stored in the storage unit 50 includes, in addition to a first route C1 from the parking space SP to the parking-lot entrance/exit B, a second route C2 from the parking-lot entrance/exit B to a location on the public road OL at the predefined distance L from the parking-lot entrance/exit B. The first route C1 is a route in the parking lot PL along the public road OL. The second route C2 is a route on the public road OL.

The vehicle control unit 53 exits the learning process after notifying the driver via the HMI 45 at step S150 that storing of various items of information is completed. In this process, it is preferable that the storage-related information regarding storing of route information by the route storage unit 54 in the storage unit 50 is notified to the driver via the HMI 45 as a notification device. This storage-related information preferably includes at least one of information about initiation of storing of route information in the storage unit 50 and information about termination of storing of route information in the storage unit 50. For example, the vehicle control unit 53 notifies the driver of the learning initiation position and the learning termination position as storage-related information by superimposing a mark or frame indicating each position on the camera-captured image displayed on the display unit of the vehicle V or the like. The vehicle control unit 53 may also notify the driver of the travel route of the vehicle V during the learning process and the surroundings of the travel route. The learning process from step S100 to step S150 is performed by the route storage unit 54 of the vehicle control unit 53.

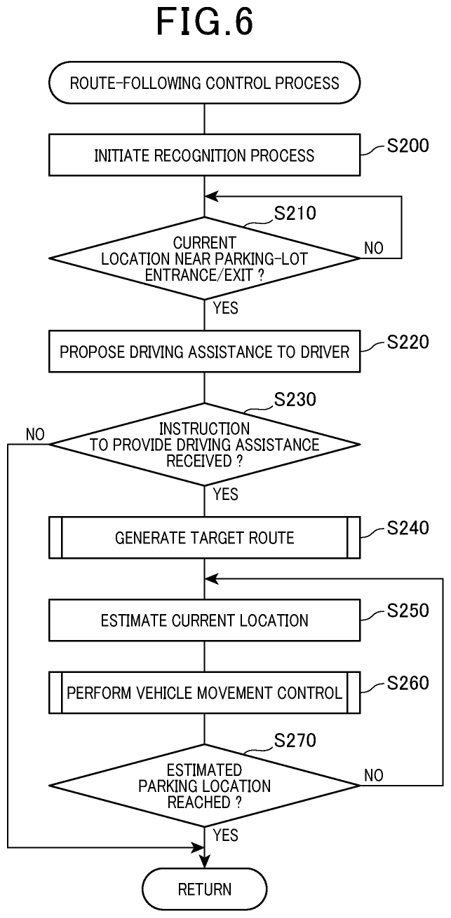

Next, the route-following control process for automatically moving the vehicle V along the target route to the parking space SP will now be described with reference to the flowchart illustrated in FIG. 6. The route-following control process illustrated in FIG. 6 is performed by the vehicle control unit 53 every predefined control cycle under the condition that the learning process has been performed at least once. The steps shown in this flowchart are implemented by the respective functional blocks of the driving assistance device 5. The steps implementing this process is also understood as respective steps implementing the driving assistance method.

As illustrated in FIG. 6, the vehicle control unit 53 initiates a recognition process at step S200. In this recognition process, the vehicle control unit 53 receives sensing information from the surroundings monitoring sensors 3 and initiates scene recognition, three-dimensional object recognition, and free space recognition described above based on the received sensing information.

Subsequently, at step S210, the vehicle control unit 53 determines whether the current location of the vehicle V is near the entrance/exit B of the home parking lot PL. Specifically, the vehicle control unit 53 determines whether the current location of the vehicle V is near the parking-lot entrance/exit B by using the sensing information from the surroundings monitoring sensors 3, the map database 35 and the GPS 36.

The vehicle control unit 53 waits if the current location of the vehicle V is not near the parking-lot entrance/exit B, and proceeds to step S220 if the current location of the vehicle V is near the parking-lot entrance/exit B. Upon proceeding to step S220, the vehicle control unit 53 proposes driving assistance for the parking operation to the driver via the HMI 45. Then, at step S230, the vehicle control unit 53 determines whether an instruction to provide driving assistance for the parking operation has been received from the driver via the HMI 45.

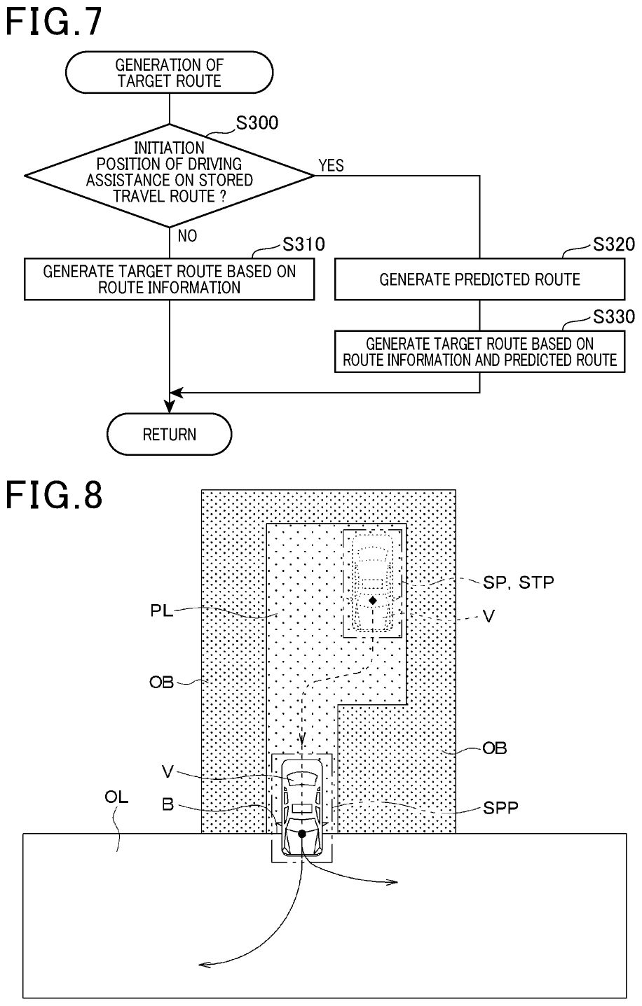

If the vehicle control unit 53 has not received any instruction from the driver to provide driving assistance for the parking operation, the vehicle control unit 53 skips the subsequent steps and exits this route-following control process. On the other hand, if the vehicle control unit 53 has received an instruction from the driver to provide driving assistance for the parking operation, the vehicle control unit 53 performs a target route generation process at step S240. The process at step S240 is performed by the route generation unit 55 of the vehicle control unit 53. In the following, the target route generation process will now be described with reference to the flowchart illustrated in FIG. 7. The process illustrated in FIG. 7 is performed by the route generation unit 55 of the vehicle control unit 53.

As illustrated in FIG. 7, at step S300, the vehicle control unit 53 determines whether the assistance initiation position for the parking operation is on the travel route stored in the storage unit 50. That is, the vehicle control unit 53 determines whether there is route information at the assistance initiation position for the parking operation. The assistance initiation position for the parking operation is a location of the vehicle V when the driver provided an instruction to perform driving assistance for the parking operation.

If the assistance initiation position is on the travel route stored in the storage unit 50, the vehicle control unit 53, at step S310, generates a target route to be traveled by the vehicle V when the vehicle V is parked based on route information including the travel route of the vehicle V during the learning process.

On the other hand, if the assistance initiation position for the parking operation is not on the travel route stored in the storage unit 50, no information about the route from the assistance initiation position to the travel route is stored in the storage unit 50, making it difficult to generate a target route from the route information including the travel route of the vehicle V during the learning process. Thus, if the assistance initiation position is not on the travel route stored in the storage unit 50, the vehicle control unit 53, at step S320, acquires road information around the parking space SP and generates a route from the assistance initiation position to the travel route as a predicted route based on the road information. For example, the vehicle control unit 53 acquires the road information around the parking space SP using the map database 35 and the GPS 36, and generates a predicted route from the acquired road information.

Subsequently, at step S330, the vehicle control unit 53 generates a target route to be traveled by the vehicle V when the vehicle V is parked, based on the predicted route and the route information including the travel route of the vehicle V during the learning process, etc.

Upon the target route being calculated in the manner as described above, the vehicle control unit 53 proceeds to step S250 as illustrated in FIG. 6. At step S250, the vehicle control unit 53 estimates the current location of the vehicle V based on the sensing information stored in the storage unit 50 and the sensing information acquired sequentially by the surroundings monitoring sensors 3 during driving assistance.

At step S260, the vehicle control unit 53 automatically moves the vehicle V to the parking space SP by performing vehicle movement control, such as acceleration/deceleration control and steering control of the vehicle V. Specifically, the vehicle control unit 53 outputs control signals to various ECUs 4 so that the vehicle V reaches the parking space SP along the target route. Thereafter, at step S270, the vehicle control unit 53 determines whether the vehicle V has reached the parking space SP. The vehicle control unit 53 returns to step S250 if the vehicle V has not reached the parking space SP, and exits the assistance process when the vehicle V reaches the parking space SP. The steps S250, S260, and S270 are performed by the route-following control unit 57 of the vehicle control unit 53.

The driving assistance device 5 described above includes the route storage unit 54 that stores in the storage unit 50 route information including the travel route that the vehicle V travels when the driver performs any one of the parking operation of the vehicle V into the parking space SP and the unparking operation of the vehicle V from the parking space SP. The driving assistance device 5 includes the route generation unit 55 that generates a target route to be traveled by the vehicle V when the vehicle V is parked or unparked based on the route information. The route storage unit 54 automatically initiates or terminates storing of route information in the storage unit 50 based on at least the relationship between the parking-lot entrance/exit B, which is the boundary between the public road OL and the parking lot PL, and the current location of the vehicle V when the driver performs any one of the parking operation and the unparking operation.

In such a configuration that storing of the travel route in the storage unit 50 is automatically initiated or terminated based on the parking-lot entrance/exit B, the load on the driver associated with generation of the target route can be reduced, as compared to the case where the driver specifies the timing for initiating or terminating storing of route information. In particular, safety can be sufficiently ensured because the driver does not need to perform the operations of initiating and terminating storing of route information on a public road OL.

According to the driving assistance device 5 of the present embodiment, the following advantages can be achieved.
(1) When the driver performs the unparking operation, the route storage unit 54 automatically terminates storing of route information in the storage unit 50 based on the relationship between the current location of the vehicle V and the parking-lot entrance/exit B. Since the unparking operation from the parking space SP causes the vehicle V to depart from a standstill, it is easier for the driver to recognize the surroundings of the vehicle V and the operation of the vehicle V tends to be simpler for the driver as compared to the parking operation to park the vehicle V in the parking space SP. Therefore, automatically storing in the storage unit 50 route information when the driver performs the unparking operation allows generation of a more preferable target route to be expected.
(2) The route storage unit 54 automatically terminates storing of route information when the vehicle V has traveled a predefined distance L or more away from the predefined parking-lot entrance/exit B after departing from the parking space SP. As a result, the driver does not need to specify the end point of the travel route to be stored in the storage unit 50. This can reduce the driver's load associated with generation of the target route.
(3) The predefined distance L is set to a value greater than zero. This allows the driver to be assisted in driving the vehicle V not only in the section from the parking space SP to the parking-lot entrance/exit B, but also on the public road OL connected to the parking-lot entrance/exit B.
(4) The route storage unit 54 automatically initiates storing of route information in response to the departure operation of the vehicle V from the parking space SP. This can reduce the driver's load associated with generation of the target route, since the driver does not need to specify the start point of the travel route to be stored in the storage unit 50.
(5) The route information stored in the storage unit 50 includes a first route C1 from the parking space SP to the parking-lot entrance/exit B and a second route C2 from the parking-lot entrance/exit B to a predefined location on the public road OL. This allows the driver to be assisted in driving the vehicle V not only in the section from the parking space SP to the parking-lot entrance/exit B, but also on the public road OL connected to the parking-lot entrance/exit B.
(6) When the assistance initiation position for the parking operation is outside the travel route stored in the storage unit 50, the route generation unit 55 generates a predicted route from the assistance initiation position to the travel route stored in the storage unit 50 based on the road information around the parking space SP. The route generation unit 55 then generates a target route based on the predicted route and route information. This allows the driver to be assisted in driving the vehicle V not only in the section from the parking space SP to the parking-lot entrance/exit B, but also on the public road OL connected to the parking-lot entrance/exit B.
(7) The driving assistance device 5 is equipped with the HMI 45 including the notification device that notifies the driver of storage-related information regarding storage of route information by the route storage unit 54 in the storage unit 50. This allows the driver to be provided with storage-related information regarding storage of route information by the route storage unit 54 in the storage unit 50.
(8) The above storage-related information includes at least one of information about initiation of storage of route information in the storage unit 50 and information about termination of storage of route information in the storage unit 50. This allows information about the start and end points of the travel route stored in the storage unit 50 to be provided to the driver. That is, the driver can be notified of what information driving assistance will be performed based on.

### Modification to First Embodiment

As illustrated in FIG. 8, for example, the driving assistance device 5 may automatically terminate storing of route information upon the vehicle V that left the parking space SP passing through the parking-lot entrance/exit B. That is, the driving assistance device 5 may automatically terminate storing of route information upon the distance between the vehicle V that left the parking space SP and the parking-lot entrance/exit B becoming zero. The driving assistance device 5 may automatically terminate storing of the route information upon elapse of a pre-defined time after the vehicle V that left the parking space SP passes through the parking-lot entrance/exit B.

The driving assistance device 5 may automatically initiate storing of the route information upon the ignition switch IG being turned on in the parking space SP.

In a case where the assistance initiation position for the parking operation is outside the travel route stored in the storage unit 50, the driving assistance device 5 may notify the driver of the predicted route to the travel route. In this case, the target route is generated regardless of the predicted route.

The driving assistance device 5 has been exemplified as one that generates a target route when parking the vehicle V based on route information acquired when the driver performs the unparking operation. Alternatively, the target route when parking the vehicle V may be generated based on route information acquired when the driver performs the parking operation.

### SECOND EMBODIMENT

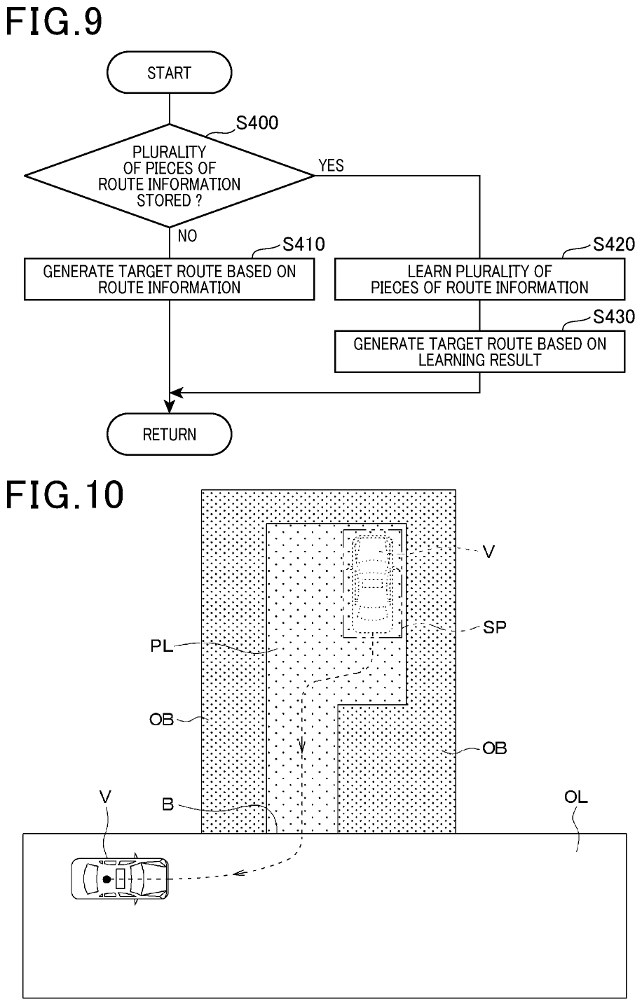

The second embodiment will now be described with reference to FIG. 9. In the present embodiment, the process of generating the target route is the same as in the first embodiment except for a part of it. In the present embodiment, the part that differs from the first embodiment will now be described mainly.

When the learning process is performed multiple times for the same parking space SP, a plurality of pieces of route information are accumulated in the storage unit 50. It is expected that a more appropriate target route can be generated by increasing the amount of route information for generating the target route. Here, the “plurality of pieces of route information” are information stored in the storage unit 50 during learning process performed at different times.

In light of the foregoing, the driving assistance device 5 of the present embodiment stores route information in the storage unit 50 when the vehicle has traveled different travel routes. Since the storage capacity of the storage unit 50 is not infinite, it is preferable that route information is stored in the storage unit 50 up to, for example, the last two or three times.

The driving assistance device 5 learns the plurality of pieces of route information stored in the storage unit 50 and generates a target route suitable for the parking operation based on the result of learning. In the following, the process of generating the target route according to the present embodiment will now be described with reference to the flowchart illustrated in FIG. 9. The process illustrated in FIG. 9 is performed by the route generation unit 55 of the vehicle control unit 53.

As illustrated in FIG. 9, at step S400, the vehicle control unit 53 determines whether a plurality of pieces of route information are stored in the storage unit 50. If a plurality of pieces of route information are not stored in the storage unit 50, the vehicle control unit 53 generates, at step S410, a target route to be traveled by the vehicle V when the vehicle V is parked, based on route information including the travel route of the vehicle V during the learning process.

On the other hand, if a plurality of pieces of route information are stored in the storage unit 50, the vehicle control unit 53 learns a plurality of pieces of route information at step S420. At step S420, for example, the vehicle control unit 53 extracts route information acquired when there are a small number of turns of the vehicle V and route information acquired when there are small amounts of various types of operations, such as operations associated with acceleration/deceleration of the vehicle V and operations associated with turns of the vehicle V.

The vehicle control unit 53 then generates a target route based on a learning result at step S430. For example, based on the learning result, the vehicle control unit 53 generates a target route that can reduce the number of turns and amounts of various types of operations of the vehicle V.

Other details are the same as in the first embodiment. The driving assistance device 5 of the present embodiment can provide the same advantages as in the first embodiment, which can be achieved from a common or equivalent configuration to that of the first embodiment.

The present embodiment can provide the following advantages.
(1) The vehicle control unit 53, which is a constituent of the route storage unit 54, stores in the storage unit 50 route information about different travel routes traveled. The vehicle control unit 53, which is a constituent of the route generation unit 55, learns a plurality of pieces of route information stored in the storage unit 50 and generates a target route suitable for the parking operation based on the learning result. This allows generation of a more preferable target route to be expected.

### Modification to Second Embodiment

The driving assistance device 5 may at least partially update the route information stored in the storage unit 50 each time the learning process is performed. This can reduce the storage capacity required for the storage unit 50.

### THIRD EMBODIMENT

The third embodiment will now be described with reference to FIGS. 10 to 14. The present embodiment differs from the first embodiment in that the present embodiment provides driving assistance when the vehicle V is unparked. In the present embodiment, the part that differs from the first embodiment will now be described mainly.

The driving assistance device 5 of the present embodiment supports the unparking operation of the vehicle V from a parking space SP, as illustrated in FIG. 10. Although FIG. 10 illustrates a situation where the vehicle is unparked in the backward direction, driving assistance by the driving assistance device 5 may be implemented not only when the vehicle is unparked in the backward direction, but also when the vehicle is unparked in the forward direction.

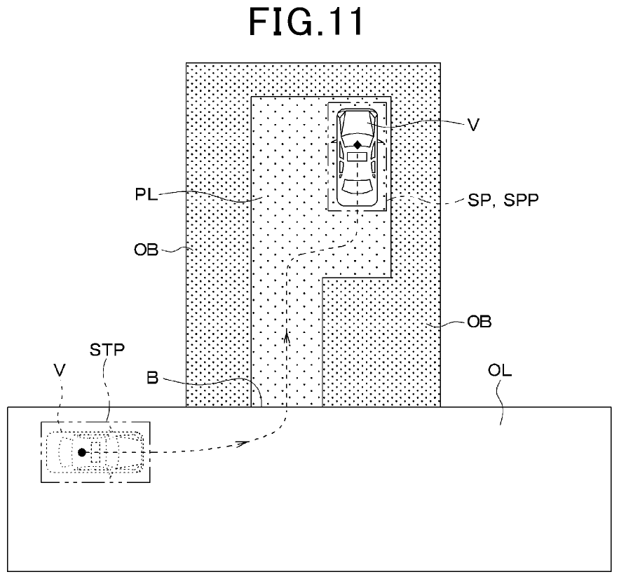

As illustrated in FIG. 11, for example, the driving assistance device 5 stores route information in the storage unit 50 when the parking operation of the vehicle V is performed by the driver. The driving assistance device 5 then performs various types of control for target route generation and driving assistance based on the route information stored in the storage unit 50 and the route information acquired by the recognition processing unit 51 during driving assistance. As illustrated in FIG. 10, for example, the driving assistance device 5 may store route information acquired sequentially by the recognition processing unit 51 in the storage unit 50 when the unparking operation of the vehicle V is performed by the driver.

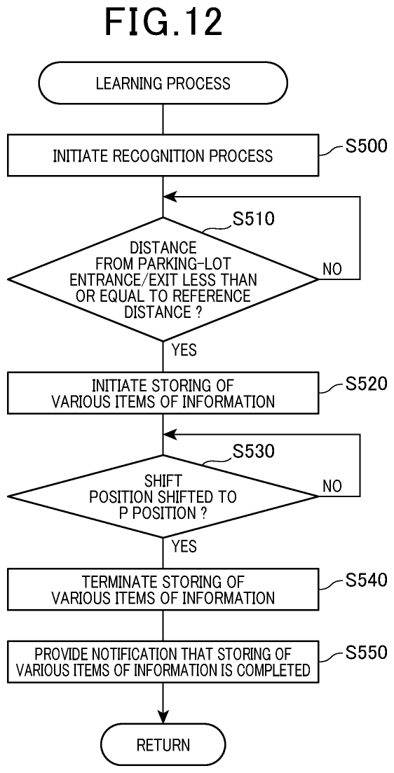

In the learning process of the present embodiment, when the driver performs the parking operation, storing of route information in the storage unit 50 is automatically initiated based on the current location of the vehicle V and the positional relationship between the parking-lot entrance/exit B and the current location of the vehicle V. In the following, the learning process of the present embodiment will now be described with reference to the flowchart illustrated in FIG. 12. The learning process illustrated in FIG. 12 is performed by the vehicle control unit 53 every predefined control cycle when an instruction to depart from the parked state is provided, such as when the ignition switch IG is turned on. The steps in this flowchart are implemented by respective functional blocks of the driving assistance device 5. The steps implementing this process is also understood as respective steps implementing the driving assistance method.

As illustrated in FIG. 12, the vehicle control unit 53 initiates the recognition process at step S500. In this recognition process, the vehicle control unit 53 receives sensing information from the surroundings monitoring sensors 3 and initiates scene recognition, three-dimensional object recognition, and free space recognition described above based on the received sensing information. In the recognition process, the vehicle control unit 53 also initiates detection of the current location of the vehicle V using the map database 35 and the GPS 36.

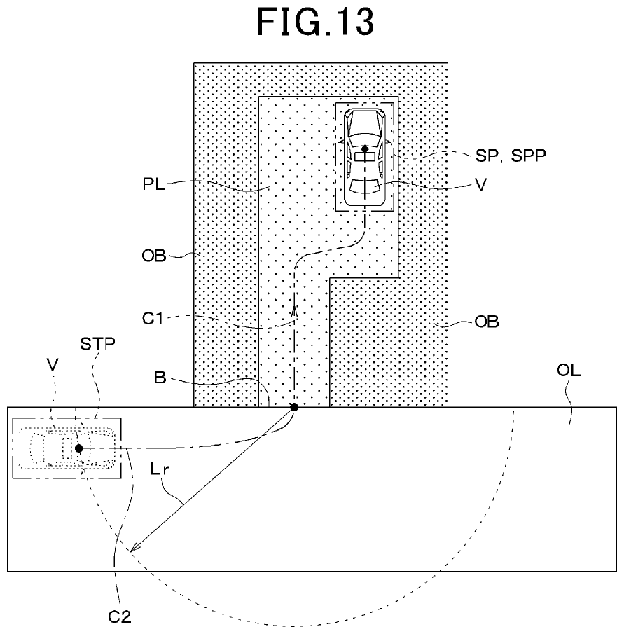

At step S510, the vehicle control unit 53 determines whether the distance between the vehicle V and the parking-lot entrance/exit B when traveling to approach the parking-lot entrance/exit B from the public road OL side is less than or equal to a reference distance Lr. The reference distance Lr is set to a value greater than zero. In this determination process, as illustrated in FIG. 13, it is determined whether the current location of the vehicle V is in an area within the reference distance Lr from a reference point BP set at the parking-lot entrance/exit B on the public road OL.

The vehicle control unit 53 waits if the distance between the vehicle V and the vehicle parking-lot entrance/exit B on the public road OL exceeds the reference distance Lr, and proceeds to step S520 if the distance between the vehicle V and the vehicle parking-lot entrance/exit B on the public road OL is less than or equal to the reference distance Lr.

The vehicle control unit 53, at step S520, initiates storing of various items of information necessary for driving assistance. For example, the vehicle control unit 53 stores in the storage unit 50 route information sequentially acquired by the recognition processing unit 51, including targets on the travel route of the vehicle V, free spaces in which the vehicle V can be parked, and parking locations.

At step S530, the vehicle control unit 53 determines whether the vehicle has arrived at the parking space SP and the shift position has been shifted to the P position, which indicates parking of the vehicle V. That is, the vehicle control unit 53 determines the presence or absence of the parking operation of the vehicle V. The predefined parking space SP is, for example, a place that the driver has registered previously with the navigation system or the like as a place where driving assistance is received.

The vehicle control unit 53 waits if the shift position has not been shifted to the P position. If the shift position has been shifted to the P position, the vehicle control unit 53 proceeds to step S540 to terminate storing of various items of information.

Here, the route information stored in the storage unit 50 includes, in addition to a first route C1 from the parking-lot entrance/exit B to the parking space SP, a second route C2 from the parking-lot entrance/exit B to a location on the public road OL at the predefined distance L from the parking-lot entrance/exit B. The first route C1 is a route in the parking lot PL along the public road OL. The second route C2 is a route on the public road OL.

The vehicle control unit 53 exits the learning process after notifying the driver via the HMI 45 at step S550 that storing of various items of information is completed. Since this step is the same as step S150 in the first embodiment, the description thereof will be omitted. The learning process from step S500 to step S550 is performed by the route storage unit 54 of the vehicle control unit 53.

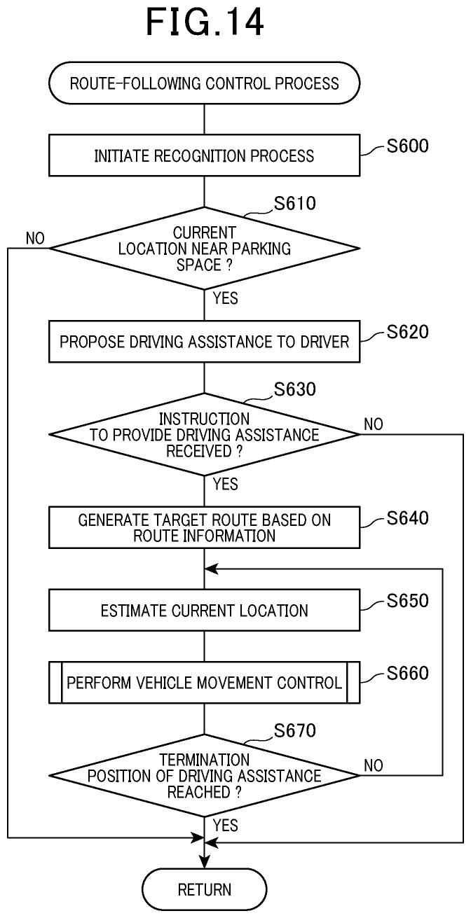

Next, the route-following control process for automatically moving the vehicle V from the parking space SP along the target route will now be described with reference to the flowchart illustrated in FIG. 14. The route-following control process illustrated in FIG. 14 is performed when the ignition switch IG of the vehicle V is turned on under the condition that the learning process has been performed at least once. The steps shown in this flowchart are implemented by the respective functional blocks of the driving assistance device 5. The steps implementing this process may also be understood as respective steps implementing the driving assistance method.

As illustrated in FIG. 14, the vehicle control unit 53 initiates a recognition process at step S600. In this recognition process, the vehicle control unit 53 receives sensing information from the surroundings monitoring sensors 3 and initiates scene recognition, three-dimensional object recognition, and free space recognition described above based on the received sensing information.

Subsequently, at step S610, the vehicle control unit 53 determines whether the current location of the vehicle V is near a parking space SP in the home parking lot PL. Specifically, the vehicle control unit 53 determines whether the current location of the vehicle V is near the parking space SP by using the sensing information from the surroundings monitoring sensors 3, the map database 35 and the GPS 36.

If the current location of the vehicle V is near the parking space SP, the vehicle control unit 53 proceeds to step S620. If the current location of the vehicle V is not near the parking space SP, the vehicle control unit 53 skips the subsequent steps and exits the route route-following control process. Upon proceeding to step S620, the vehicle control unit 53 proposes driving assistance for the unparking operation to the driver via the HMI 45. Then, at step S630, the vehicle control unit 53 determines whether an instruction to provide driving assistance for the unparking operation has been received from the driver via the HMI 45.

If the vehicle control unit 53 has not received from the driver an instruction to provide driving assistance for the unparking operation, the vehicle control unit 53 skips the subsequent steps and exits this process. On the other hand, if the vehicle control unit 53 has received from the driver an instruction to provide driving assistance for the unparking operation, the vehicle control unit 53 performs the target route generation process at step S640. This step S640 is performed by the route generation unit 55 of the vehicle control unit 53. Specifically, the vehicle control unit 53 generates a target route to be traveled by the vehicle V when the vehicle V is unparked based on route information including the travel route of the vehicle V during the learning unit process, etc.

Subsequently, at step S650, the vehicle control unit 53 estimates the current location of the vehicle V based on the sensing information stored in the storage unit 50 and sensing information sequentially acquired by the surrounding monitoring sensors 3 during driving assistance.

Subsequently, at step S660, the vehicle control unit 53 automatically moves the vehicle V from the parking space SP to the assistance termination position by performing vehicle movement control such as acceleration/deceleration control and steering control of the vehicle V. Specifically, the vehicle control unit 53 outputs control signals to various ECUs 4 so that the vehicle V follows the target route to reach the assistance termination position. Thereafter, at step S670, the vehicle control unit 53 determines whether the vehicle V has reached the assistance termination position. The assistance termination position is set, for example, to a location designated by the driver in advance or to a representative location such as a parking-lot entrance/exit B, etc.

The vehicle control unit 53 returns to step S650 unless the vehicle V has reached the assistance termination position. If the vehicle V has reached the assistance termination position, the vehicle control unit 53 exits the assistance process. Steps S650, S660, and S670 are performed by the route-following control unit 57 of the vehicle control unit 53.

Other details are the same as in the first embodiment. The driving assistance device 5 of the present embodiment can provide the same advantages as in the first embodiment, which can be achieved from a common or equivalent configuration to that of the first embodiment.

The present embodiment can provide the following advantages.
(1) When the driver performs the parking operation, the route storage unit 54 automatically initiates storing of route information in the storage unit 50 based on the positional relationship between the current location of the vehicle V and the parking-lot entrance/exit B. In this manner, automatically storing route information in the storage unit 50 when the driver performs the parking operation can reduce the driver's load associated with generation of the target route.
(2) The route storage unit 54 automatically initiates storing of route information in the storage unit 50 upon the distance between the vehicle V and the parking-lot entrance/exit B when traveling to approach the parking-lot entrance/exit B from the public road OL side becoming the reference distance Lr or less. This can reduce the driver's load associated with generation of the target route, since the driver does not need to specify the start point of the travel route to be stored in the storage unit 50.
(3) The route storage unit 54 terminates storing of route information in the storage unit 50 in response to the parking operation of the vehicle V into the parking space SP. This can reduce the driver's load associated with generation of the target route, since the driver does not need to specify the end point of the travel route to be stored in the storage unit 50.

### Modification to Third Embodiment

The driving assistance device 5 may, for example, automatically initiate storing of route information upon the vehicle V passing through the parking-lot entrance/exit B. That is, the driving assistance device 5 may automatically initiate storing of route information upon the distance between the vehicle V and the parking-lot entrance/exit B becoming zero.

The driving assistance device 5 may automatically terminate storing of route information upon the ignition switch IG being turned off in the parking space SP.

The driving assistance device 5 has been exemplified as one that generates a target route when the vehicle V is unparked based on route information acquired when the driver performs the parking operation. Alternatively, or additionally, the driving assistance device 5 may generate a target route when the vehicle V is unparked based on route information acquired when the driver performs the unparking operation.

### OTHER EMBODIMENTS

While the specific embodiments of the present disclosure have been described above, the present disclosure is not limited to the above-described embodiments, and may incorporate various modifications.

In the embodiments described above, the detailed configuration of the driving assistance device 5, the detailed contents of the learning process, and the detailed contents of the route-following control process have been described, but may not be limited to these details, and some of these contents may be different.

In the embodiments described above, parking assistance and unparking assistance have been exemplified as being implemented separately. The driving assistance device 5 may also be configured to implement both parking assistance and unparking assistance.

In the embodiments described above, the driving assistance device 5 has been exemplified as notifying via the HMI 45 the driver of the storage-related information regarding storing of route information in the storage unit 50. The driving assistance device 5 may also be configured to notify the driver via a device other than the HMI 45. It is not essential to notify the driver of the storage-related information.

In the embodiments described above, the driving assistance device 5 has been exemplified as being applied to driving assistance in a narrow parking lot PL in front of the driver's home. The driving assistance device 5 may also be configured to be applied to driving assistance in other lots other than the parking lot PL in front of the driver's home.

Although in the above embodiments autonomous driving control has been described as including diving assistance control by the autonomous driving system 1, diving assistance control may only have to include control such as generating a target route for moving the own vehicle to park in a parking space SP, regardless of whether diving assistance is autonomous driving. For example, driving assistance may include simply displaying the target route on a display and using it as an indicator for the driver to park or unpark the own vehicle by his/her own driving. It is not essential that route-following control is performed to automatically move the own vehicle along the target route.

It is needless to say that the elements constituting the above embodiments are not necessarily essential unless explicitly stated as essential or obviously considered essential in principle.

In addition, when a numerical value such as the number, value, amount, or range of a component(s) of any of the above-described embodiments is mentioned, it is not limited to the specific number or value unless expressly stated otherwise or it is obviously limited to the specific number or value in principle, etc.

When the shape, positional relationship, or the like of a component(s) or the like of any of the embodiments is mentioned, it is not limited to the specific shape, positional relationship, or the like unless explicitly stated otherwise or it is limited to the specific shape, positional relationship, or the like in principle, etc.

Each control unit and the methods thereof described in the present disclosure may be realized by a dedicated computer provided by configuring a processor and memory programmed to perform one or more functions embodied in a computer program. Alternatively, each control unit and the method thereof described in the present disclosure may be realized by a dedicated computer provided by configuring a processor with one or more dedicated hardware logic circuits. Alternatively, each control unit and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

What is claimed is:

1. A driving assistance device for assisting a driver in driving operations of a vehicle between a public road and a parking space in a lot along the public road, comprising:
a route storage unit configured to store in a storage unit route information including a travel route that the vehicle travels when the driver performs one of a parking operation of the vehicle into the parking space and an unparking operation of the vehicle from the parking space, and an environmental situation of the vehicle in the travel route, the route storage unit being further configured to, when the driver performs the one of the parking operation and the unparking operation, automatically initiate or terminate storing of the route information in the storage unit based on at least a relationship between a parking-lot entrance/exit, which is a boundary between the public road and the lot, and a current location of the vehicle; and
a route generation unit configured to generate a target route to be traveled by the vehicle when the vehicle is parked or unparked based on the route information.

2. The driving assistance device according to claim 1, wherein
the route storage unit is configured to, when the driver performs the unparking operation, automatically terminate storing of the route information in the storage unit based on the relationship between the current location of the vehicle and the parking-lot entrance/exit.

3. The driving assistance device according to claim 2, wherein
the route storage unit is configured to automatically terminate storing of the route information in response to the vehicle having traveled a predefined distance or more away from the predefined parking-lot entrance/exit after departing from the parking space.

4. The driving assistance device according to claim 3, wherein
the predefined distance is set to a value greater than zero.

5. The driving assistance device according to claim 2, wherein
the route storage unit is configured to automatically initiate storing of the route information in response to a departure operation of the vehicle from the parking space.

6. The driving assistance device according to claim 1, wherein
the route storage unit is configured to, when the driver performs the parking operation, automatically initiate storing of the route information in the storage unit based on the relationship between the current location of the vehicle and the parking-lot entrance/exit.

7. The driving assistance device according to claim 6, wherein
the route storage unit is configured to automatically initiate storing of the route information in the storage unit in response to a distance between the vehicle and the parking-lot entrance/exit when traveling to approach the parking-lot entrance/exit from a public road side becoming a reference distance or less.

8. The driving assistance device according to claim 6, wherein
the route storage unit is configured to terminate storing of the route information in the storage unit in response to the parking operation of the vehicle into the parking space.

9. The driving assistance device according to claim 1, wherein
the route information stored in the storage unit includes a first route from the parking space to the parking-lot entrance/exit and a second route from the parking-lot entrance/exit to a predefined location on the public road.

10. The driving assistance device according to claim 1, wherein
the route storage unit is configured to store the route information in the storage unit when the vehicle has traveled different travel routes, and
the route generation unit is configured to learn a plurality of pieces of the route information stored in the storage unit and generate a target route suitable for the parking operation or the unparking operation based on a learning result.

11. The driving assistance device according to claim 1, wherein
the route generation unit is configured to, when an assistance initiation position for the parking operation is outside the travel route stored in the storage unit, generate a predicted route from the assistance initiation position to the travel route based on road information around the parking space, and generate the target route based on the predicted route and the route information.

12. The driving assistance device according to claim 1, further comprising a notification device configured to notify the driver of storage-related information regarding storage of the route information by the route storage unit in the storage unit.

13. The driving assistance device according to claim 12, wherein
the storage-related information includes at least one of information about initiation of storing of the route information in the storage unit and information about termination of storing of the route information in the storage unit.

14. A driving assistance method for assisting a driver in driving operations of a vehicle between a public road and a parking space in a lot along the public road, comprising:
storing in a storage unit route information including a travel route that the vehicle travels when the driver performs one of a parking operation of the vehicle into the parking space and an unparking operation of the vehicle from the parking space, and an environmental situation of the vehicle in the travel route, storing in a storage unit route information comprising;
when the driver performs the one of the parking operation and the unparking operation, automatically initiating or terminating storing of the route information in the storage unit based on at least a relationship between a parking-lot entrance/exit, which is a boundary between the public road and the lot, and a current location of the vehicle; and
generating a target route to be traveled by the vehicle when the vehicle is parked or unparked based on the route information.

15. A driving assistance device for assisting a driver in driving operations of a vehicle between a public road and a parking space in a lot along the public road, comprising:
a non-transitory memory storing one or more computer programs; and
a processor executing the one or more computer programs to:
store in a storage unit route information including a travel route that the vehicle travels when the driver performs one of a parking operation of the vehicle into the parking space and an unparking operation of the vehicle from the parking space, and an environmental situation of the vehicle in the travel route;
when the driver performs the one of the parking operation and the unparking operation, automatically initiate or terminate storing of the route information in the storage unit based on at least a relationship between a parking-lot entrance/exit, which is a boundary between the public road and the lot, and a current location of the vehicle; and
generate a target route to be traveled by the vehicle when the vehicle is parked or unparked based on the route information.
